(19) United States
(12) Patent Application Publication
(10) Pub. No.: US 2007/0088472 A1
(43) Pub. Date: Apr. 19, 2007

(54) Method and apparatus for validating OBD repairs

(75) Inventors: Donald W. Ganzhorn JR., Aurora, OH (US); Michael H. Caldwell, Stow, OH (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Ganzcorp Investments Inc.

(21) Appl. No.: 11/544,174

(22) Filed: Oct. 6, 2006

Related U.S. Application Data
(60) Provisional application No. 60/726,847, filed on Oct. 14, 2005.

(51) Int. Cl. G01M 17/00; G06F 19/00

(52) U.S. Cl. 701/33; 701/29

(57) ABSTRACT

A method is provided for validating emissions component conditions of a vehicle including the steps of operatively placing drivable wheel hubs of the vehicle under load so that the vehicle drive wheel hubs may be driven without vehicle movement and running the vehicle through an associated drive cycle associated with that vehicle. The method further includes the steps of determining if monitored emission components are in a Ready condition at the end of drive cycle, and monitoring for diagnostic trouble codes during and at the end of the drive cycle.

### RELATED APPLICATION

This application claims the benefit of U.S. Provisional Application No. 60/726,847, filed Oct. 14, 2005, which is herein incorporated by reference in its entirety.

### TECHNICAL FIELD

The present invention is directed to a method and apparatus for aiding to insure proper emissions related vehicle repairs and is particularly directed to a method and apparatus for validating emissions related vehicle repairs diagnosed via error codes and readiness codes received from a vehicle's on-board computer system through the vehicle's on-board-diagnostic connector or via a wireless interface to the vehicle's on-board computer.

### BACKGROUND OF THE INVENTION

Vehicle's emissions systems have been tested by government or state agencies in an attempt to insure compliance with federally mandated standards designed to reduce emissions that contribute to air pollution. Vehicles are equipped with emissions systems that are configured to reduce harmful emissions. The 1990 Clean Air Act required vehicle manufactures to supply a connector, and to make available and implement by 1996 on all vehicles sold in the United States, a computer interface to the vehicle's on-board computer and emissions self-diagnostic system. This system has become known as the OBD II system. Certain vehicle parameters and operating values seen and controlled by the on-board computers as it relates to the vehicle's exhaust emissions are identified in the Clean Air Act and are required to be made available to third parties at no cost from the manufacturer. The Data is known as Generic OBD II Data. The access to the vehicle's data follows standards so it is consistent between manufacturers.

In many state and governmental areas, vehicles are required to be inspected to validate the vehicle meets certain in-use emission standards. The common approach of this test prior to 2002 was for the vehicle to be taken to a test facility for tailpipe emission testing. The test station would insert a monitoring probe in the vehicle's tailpipe and run the vehicle on a dynamometer to simulate road driving conditions. The vehicle's exhaust gas emissions were monitored during the test. If the monitored gas emissions at the time of the test were within limits, the vehicle passed. Otherwise, the vehicle would fail and the owner would have to have the vehicle repaired and retested.

The tailpipe probe type testing is performed presently in many areas and in some areas, testing methods is mixed with OBD II testing with tailpipe probe testing, while yet other areas have only OBD II testing.

With regard to OBD II testing, since 1996, OBD II vehicles include self-monitoring or self-diagnostic systems that monitor the operation of its emission control system as well as other major systems on the vehicle (i.e., the transmission). As it concerns the emissions system specifically, vehicles may have as many as eleven or more monitored emission components. Three of these components are continuously monitored and eight or more are non-continuously monitored. Not all vehicles have all eleven monitored components. Continuous monitored components include ignition misfire, fuel trim, and comprehensive components. The continuous monitored components are monitored continuously upon engine start-up. The non-continuous monitored components included the oxygen sensor, the oxygen heater, the EGR system, the secondary AIR injection, the catalytic converter, the heated catalytic converter the evaporative system, the AC refrigerant and possibly the thermostat, the AIR injection, and the PCV system. The non-continuous components are monitored after a predetermined set of operating conditions are completed, and remain “Ready” or “Complete” until manually “reset” or “cleared” by a scan tool or other means. When the continuous and non-continuous components are working properly and they are sensing their associated monitored conditions within acceptable limits, the vehicle is considered to be operating properly.

If one of the emission monitors detects an improper condition, the vehicle's on-board computer reports a Diagnostic Trouble Code (“DTC”) and the Malfunction Indicator Lamp (“MIL”) is illuminated so as to alert the vehicle operator that a problem exists with the vehicle. DTC's are used to identify the malfunction that has occurred so that the correct repairs can be made to the vehicle. The DTC is downloaded by a vehicle service technician via a scan tool connected to a diagnostic port typically located under the vehicle's instrument panel.

Vehicles provide many DTC's that relate to many vehicle operating systems in addition to the vehicle emissions system. The codes are structured as five place coded information such as P0137. The first position of the code can be B for body, C for chassis, P for powertrain, or U for network. The second location is 0 for generic or 1 for manufacturer specific. The last three digits is a specific system fault designation. The specific system fault designations have been standardized in the industry.

Additional information is available from the vehicle's on-board computer which may help a technician to monitor the vehicle. Freeze Frame data associated with a DTC is available. This data corresponds to certain vehicle conditions when the DTC was set. Pending DTC's are set when a vehicle readiness monitor has cycled through a sequence and determined that an error was found but before reporting a DTC and illuminating the MIL, the vehicle's on-board computer will want to see the same failure more than once in some cases prior to illuminating the MIL.

The vehicle's on-board computer also has a data stream of vehicle information which can be scanned and displayed in whole or in part to the technician.

It is common today for vehicles manufactured after 1996 to be tested for emissions compliance using its own on-board computer system. The on-board vehicle computer monitors vehicle operating parameters related to vehicle emissions and monitors for error conditions. When a vehicle goes in for testing, if the MIL is illuminated at that time, the vehicle automatically fails. If the MIL is not illuminated, a scan tool is connected to the vehicle's diagnostic port and a testing computer, or scan tool, monitors to see if any emissions-related monitors are in a “Not-Ready” or “Incomplete” condition. As it is possible for a vehicle owner to “reset” or “clear” the memory on the vehicle's on-board computer system in an effort to extinguish the MIL, it is important to check the status of all non-continuous emissions-related vehicle readiness monitors and to fail any vehicle that does not have Completed Vehicle Readiness Monitors. Further, as all vehicle readiness monitors are set to “Incomplete” when the computer's memory is cleared, this discourages vehicle operators from attempting to circumvent the emissions test by extinguishing the MIL without first repairing/replacing the failed component(s).

Proper repair of a vehicle that has failed an emissions test, or one with an active DTC that has not been tested, requires proper diagnosis of the problem, proper repair, and confirmation of repair. Upon completion of above mentioned steps, the on-board diagnostic computer should be “reset” or “cleared”, which will extinguish the MIL and will place all emissions-related vehicle readiness monitors to “Incomplete”. Finally, and in order to bring all emissions-related monitors to a “Complete” status, the vehicle must meet some test pre-conditions and undergo a pre-determined set of operating conditions or enabling criteria, commonly referred to as a drive cycle for each individual Non-continuous Vehicle Readiness Monitor or a ganged drive cycle of individual Non-continuous vehicle readiness monitors or a comprehensive drive cycle to operate the vehicle through all of its vehicle readiness monitor cycles. Each vehicle platform has a different drive cycle specified by the manufacturer for each particular vehicle readiness monitor. Additionally some manufactures supply a comprehensive drive cycle to exercise all of the vehicle readiness monitors.

In many cases, a repair technician will perform work on a malfunctioning vehicle and will clear the computer's memory to extinguish the MIL, but will not reset the “Incomplete” vehicle readiness monitors. In some cases, an assumption is made that the vehicle operator will have driven his car a sufficient amount to satisfy the vehicle's drive cycle before the vehicle is retested so as to place the monitors back into a “Ready” or “Complete” condition. As some Drive Cycles require a specific set of conditions that are not feasible in urban areas (i.e. speed above 60-mph and throttle opening of greater than 60%), this is not always a safe assumption. Moreover, the repair technician cannot be certain that his repair has solved the problem when the vehicle leaves his shop without resetting monitors as the vehicle's on-board computer cannot detect a problem until a monitor is in a “Complete” or “Ready” state. Often, a vehicle owner finds that after driving the vehicle for a while after the repair, monitors are brought to a “Complete” status and if the repair has not been made properly, the MIL is again illuminated. This results in a return trip to the repair shop to get a proper repair of the emission system.

### SUMMARY OF THE INVENTION

In accordance with one aspect of the present invention, a method is provided for validating emissions component conditions of a vehicle comprising the steps of operatively placing drivable wheel hubs of the vehicle under load so that the vehicle drive wheel hubs may be driven without vehicle movement and running the vehicle through an associated drive cycle associated with that vehicle. The method further comprises the steps of determining if monitored emission components are in a Ready condition at the end of drive cycle, and monitoring for diagnostic trouble codes at the end of the drive cycle.

In accordance with another aspect of the present invention, a method is provided for validating emissions component conditions of a vehicle comprising the steps of operatively placing drive wheels of the vehicle on a controllable dynamometer and controlling the dynamometer in accordance with a predetermined control program associated with the vehicle so as to apply appropriate road load forces to the drive wheels of the vehicle during a drive cycle of the vehicle. The method further comprises the steps of operating the vehicle on the dynamometer through an associated drive cycle for that vehicle, determining if monitored emission components are in a Ready condition at the end of a drive cycle, and monitoring for diagnostic trouble codes and pending diagnostic trouble codes at the end of the drive cycle.

In accordance with yet another aspect of the present invention, an apparatus is provided for validating emissions component conditions of a vehicle comprising a simulator for applying appropriate road load forces to the drive hubs of the vehicle during an operation of the vehicle through a drive cycle associated with that vehicle and a vehicle speed sensor for monitoring speed of vehicle wheels as the vehicle is run on the simulator. A display is provided for displaying the vehicle drive cycle of the vehicle running on the simulator. The display simultaneously displays vehicle speed and/or throttle position and/or acceleration rate along with the associated desired vehicle speed range and/or throttle position range and/or acceleration rate range, respectively, during the vehicle drive cycle. The apparatus further includes a communication interface between the vehicle and the display for communicating the condition of the vehicle's monitored emissions components. The communication interface can be, in accordance with one example embodiment, a wireless interface, or, in accordance with another example embodiment, a scan tool.

In accordance with yet another aspect of the present invention, a computer readable medium having computer-executable instructions including receiving data from a scan tool that characterizes operating conditions of at least one control module of a vehicle, controlling a dynamometer to provide appropriate road load forces to drive hubs of the vehicle during a drive cycle of the vehicle, providing at least one indicia during the running of the vehicle on the dynamometer, and storing the data received from the scan tool in a database.

In accordance with still yet another aspect of the present invention, a method is provided for operating a vehicle on a road simulator to activate and cycle vehicle's on-board-diagnostic readiness monitors comprising the steps of identifying the vehicle's platform applying a load to drive hubs of the vehicle so as to simulate road load forces, verifying the vehicle meets pre-conditions for an on-board-diagnostic readiness monitor test, operating the vehicle through an associated drive cycle for the identified vehicle platform, and monitoring a state of readiness after the drive cycle.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a schematic block diagram of a system for validating emission repairs in accordance with an example embodiment of the present invention;

FIG. 2 is a graphical representation of a standard city drive cycle established under the EPA Federal Test Procedure over 1372 seconds;

FIG. 3 is a drive cycle of a type that a manufacture may specify for a vehicle platform;

FIGS. 4A and 4B are flow charts depicting a control process in accordance with an example embodiment of the present invention; and

FIGS. 5-10 are graphic user interface displays in accordance with an example embodiment of the present invention.

### DESCRIPTION OF PREFERRED EMBODIMENT

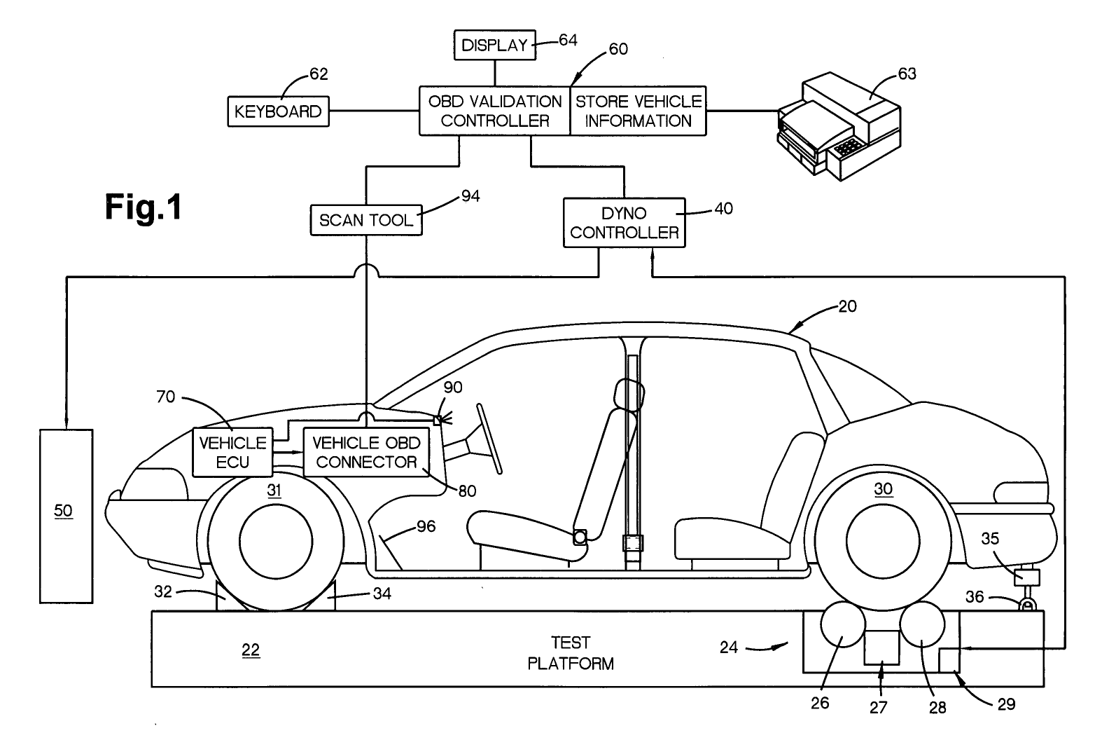

Referring to FIG. 1, a rear wheel drive vehicle 20, is driven onto a test platform 22 having a controllable dynamometer 24 with rollers 26, 28 so that the vehicle's rear wheels 30 operatively engage the rollers 26, 28 in a known manner. Moveable front 32 and rear 34 wheel chock restraint devices are positioned in front of and behind, respectively, the front wheels 31 to prevent the vehicle 20 from leaving the dynamometer. A ratchet strap 35 is attached and tighten between the vehicle 20 and the I-hook 36 attached to the test platform to secure the vehicle while operating on the dynamometer. The purpose of the dynamometer 24 is to simulate road load forces for the vehicle 20 as the vehicle 20 is being “driven” on the dynamometer. The dynamometer 24 may be of any known type such as any eddy current brake type that can apply a variable load in response to a control signal. The dynamometer may also have fixed, variable, or selectable rotating inertia attached or simulated via a device capable of simulating inertia. Rather than a dynamometer, those skilled in the art will appreciate that any loading device can be secured to the drivable hubs of the vehicle and the vehicle made immobile so that the wheel hubs could rotate without the vehicle 20 moving. As the wheel hubs rotate, this is referred to herein as the vehicle being driven.

A dynamometer controller 40 is controllably connected to the dynamometer 24 and provides the control signal so the dynamometer 24 applies the desired road load forces to the vehicle 20 under test.

Although a rear-wheel vehicle 20 is shown, those skilled in the art will appreciate that the present invention is applicable to front-wheel drive vehicles and is applicable to all-wheel drive vehicles and is applicable to multiple wheel drive vehicles including dual wheel trucks with a test platform having front and rear dynamometers. Each set of driven wheels would have an associated dynamometer. Also, the invention is applicable to gasoline, diesel, or any other fuel source vehicles including hybrid vehicles.

The dynamometer controller 40 is also connected to a cooling fan 50 placed in front of the vehicle 20 during tests to force air over the front of the vehicle and under the vehicle to cool the vehicle and simulate air crossing the vehicle as if it were being driven on the road. The dynamometer controller 40 is connected to an on-board-diagnostic (“OBD”) validation controller 60. The OBD validation controller 60 is connected to a keyboard 62, a printer 63, and a display 64. The display is, in accordance with one example embodiment of the present invention, a touch responsive display for both displaying data and inputting responses and information to the controller 60. The display 64 may be wired to the controller 60 or communicate wirelessly. The dynamometer controller 40, in accordance with one example embodiment of the present invention, has the following inputs/outputs:
Digital Inputs
   PAU Over Temp Switch
   Exhaust Air Movement Switch
   Lift Over Ride
   E-Stop
   Pulse Inputs
   Primary Speed Signal and Lift Inhibit
   Secondary Speed Lift Inhibit Speed signal
Digital Outputs
   Lift Enable
Analog Inputs
   Load Cell (excitation 5 VDC)
   Engine Rpm's (10-bit 1024)
   Weather Station Ambient Temp
   Weather Station RH
   Weather Station Barometric Pressure

The vehicle 20 includes an on-board vehicle computer 70 referred to as the vehicle electronic control unit (“ECU”), that may include one or more control modules, that monitors all vehicle internal operating systems including emissions systems of the vehicle. The specific emissions systems monitored of vehicle 20 are the continuous vehicle readiness monitors which monitor items including ignition misfire, fuel trim, and comprehensive components and the non-continuous vehicle readiness monitors that monitor items including the oxygen sensor, the oxygen heater, the EGR system, the Secondary AIR injection, the catalytic converter, the heated catalytic converter, the evaporative system, the AC refrigerant, and possibly the AIR injection, the thermostat, and the PCV system. The continuous vehicle readiness monitors continuously monitor engine components upon engine start-up. The non-continuous vehicle readiness components are monitored after a predetermined set of operating conditions are completed by the vehicle. This is known as a “vehicle readiness monitors cycle test.” When the continuous and non-continuous components are working properly and they are sensing their associated components and compare the values to conditions within acceptable limits, then no DTC codes are set and the vehicle readiness monitors change states to Ready or Complete. The vehicle ECU 70 is connected to a vehicle OBD connector 80.

The pin connections on the OBD connector are populated in accordance with industry standards and are as follows:
Pin 2—J1850 Bus+
Pin 4—Chassis Ground
Pin 5—Signal Ground
Pin 6—CAN High (J-2284)
Pin 7—ISO 9141-2 K Line
Pin 10—J1850 Bus
Pin 14—CAN Low (J-2284)
Pin 15—ISO 9141-2 L Line
Pin 16—Battery Power

The vehicle ECU 70 is also connected to the Maintenance Indicator Lamp (“MIL”) 90; also know as the check engine light. The MIL is illuminated at key-on of the ignition as a lamp check and upon failure within the emissions system. The Environmental Protection Agency (“EPA”) has set forth guidelines and pass/fail/rejection criteria for OBD emissions test. The different States have different actual guidelines for what constitutes an emissions failure. Typically, the MIL being lit alone is sufficient enough of a failure to require repair of the emissions system. Some States require two vehicle readiness monitors to be Not-Ready or Not-Complete while other States mandate that one vehicle readiness monitor be Not-Ready or Not-Complete is a sufficient failure to require repair.

The OBD validation controller 60 is connected to the OBD connector 80 through a scan tool 94. The scan tool 94 provides the communication link necessary between the controller 60 and the vehicle ECU 70 via the vehicle's communication protocol. The use of scan tools for such vehicle communication protocol is well known in the art.

Assume the vehicle's readiness monitors were all in a Not-Ready condition but the vehicle's emission system was all in proper working order (as could occur if the battery was disconnected), the vehicle must be driven through, what is known as a OBD drive cycle(s) before all vehicle readiness monitors are set to a Ready condition. The OBD controller 60 can reset the MIL to turn off the MIL but this will not reset the DTC's that, in turn, will turn off the MIL, erase the freeze data, and clear current and pending DTC, and it will set all of the not continuous vehicle readiness monitors to a Not-Ready condition. The vehicle must be driven through an OBD drive cycle(s) to activate the vehicle readiness monitors cycle test so they change states back to Ready.

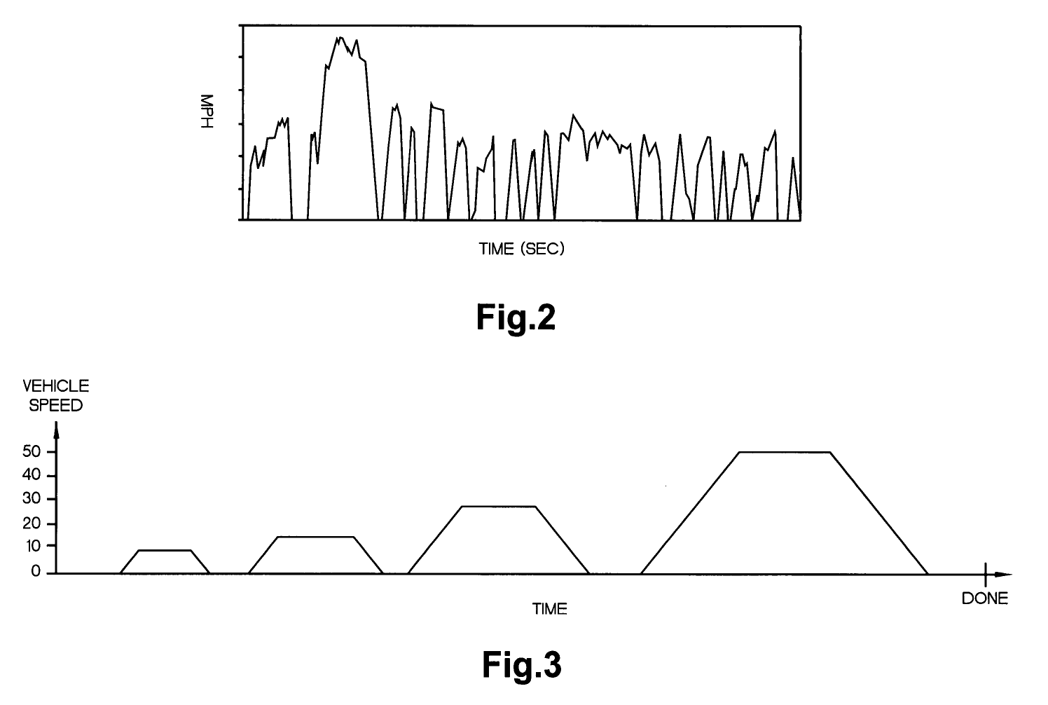

FIG. 2 shows a test cycle Urban Driving Cycle found in the Code of Federal Register Part 40 used for testing emissions on vehicles. Some manufactures have chosen this test cycle combined with the Highway Driving Cycle as a comprehensive drive cycle for re-setting the vehicle's readiness monitor status. It indicates that if a vehicle is driven at those speeds over a 1372 second period of time one or more times combined with the highway drive cycle, all vehicle readiness monitors will reset to a Ready condition

Manufactures of vehicles can specify their own drive cycle for a vehicle necessary to insure a vehicle readiness monitor reset. This is typically specified by a manufacturer for a particular vehicle platform. The Manufactures define these in a few ways: 1) Individual Monitor Specific drive cycle, 2) Ganged Individual Monitor Specific drive cycles, and 3) Comprehensive Monitor drive cycles. FIG. 3 shows an example of what a hypothetical drive cycle might look like for a vehicle platform specified by a manufacturer. A manufacturer's drive cycle may be less rigorous than that outlined in the Code of Federal Register shown in FIG. 2. Additionally not all driver's traces are speed and time dependent; they can also be throttle position dependent, acceleration dependent, deceleration dependent, as well as other vehicle and dynamometer parameter dependent. Again, it is to be appreciated that the vehicle 20 is not moving but it is a simulated vehicle speed from rotation of the drive wheels. Therefore, speed, acceleration, and deceleration refer to the simulated effects.

In accordance with one example embodiment of the present invention, assume a vehicle has been repaired after an emissions failure and the DTC are cleared which causes the MIL to turn off, the vehicle readiness monitors all go to a Not-Ready condition. The vehicle is driven onto the test platform 22 and the OBD controller 60, via the keyboard or touch display 64, activates the dynamometer 24 to put rollers 26, 28 in position. The wheel chocks 32, 34 are put into position and restraint ratchet strap 35 is secured to the vehicle and the I-hook 36 on the test platform. The scan tool 94 is connected to the OBD connector 80. Information about the vehicle 20 is either gathered from the vehicles ECU 70 if available or entered into the controller 60 and the drive cycle for that vehicle is recalled from the stored vehicle information memory in the OBD validation controller 60.

The technician selects the appropriate drive cycle according to the vehicle readiness monitors required to be re-set. The operator may select a comprehensive drive cycle for the vehicle, an individual specific monitor drive cycle, or a series of ganged specific drive cycles for the vehicle. Additionally, the operator can perform a free form drive cycle in which case he drives the vehicle without a drive cycle display but the information in the vehicle is monitored to see if the vehicle's readiness monitors test has completed. The drive cycle for that vehicle is then displayed on the display 64. The test operator is then instructed to control the vehicle's accelerator pedal 96 so as to maintain vehicle throttle position, acceleration, and speed over time to achieve the drive cycle shown on the display. At the same time, data from the vehicle is displayed and readiness monitors status are checked and displayed. At the end of the drive cycle run on the dynamometer, all of the required number of vehicle readiness monitors should have changed to Ready or if during the drive cycle, all required vehicle readiness monitors have cycled to the Ready state, then the drive cycle should be concluded. In some cases, not all monitors may be required to be in a Ready state. This will be governed by the intent of the test and possibly the state emissions program which allows one or more vehicle readiness monitors not to be in the Ready status to pass the emissions test. Then, the drivers trace test is concluded and the vehicle is ready for emission testing.

Drive cycles and, in turn, the resetting of the vehicle readiness monitors, are functionally related to several variables and not just vehicle speed and time. These variables include time, distance of travel, engine temperature, ambient air temperature, fuel tank level, fuel type, throttle position, vehicle speed, gear position, battery voltage, and barometric pressure. All of this information is accounted for in the OBD validation controller 60.

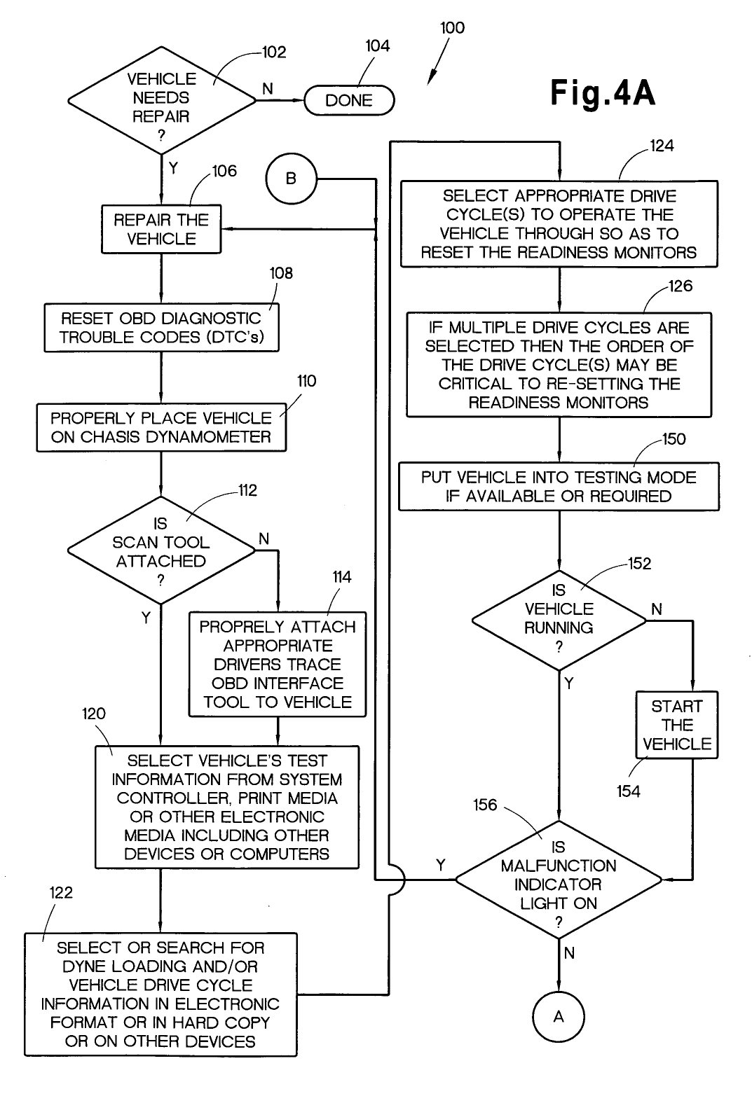

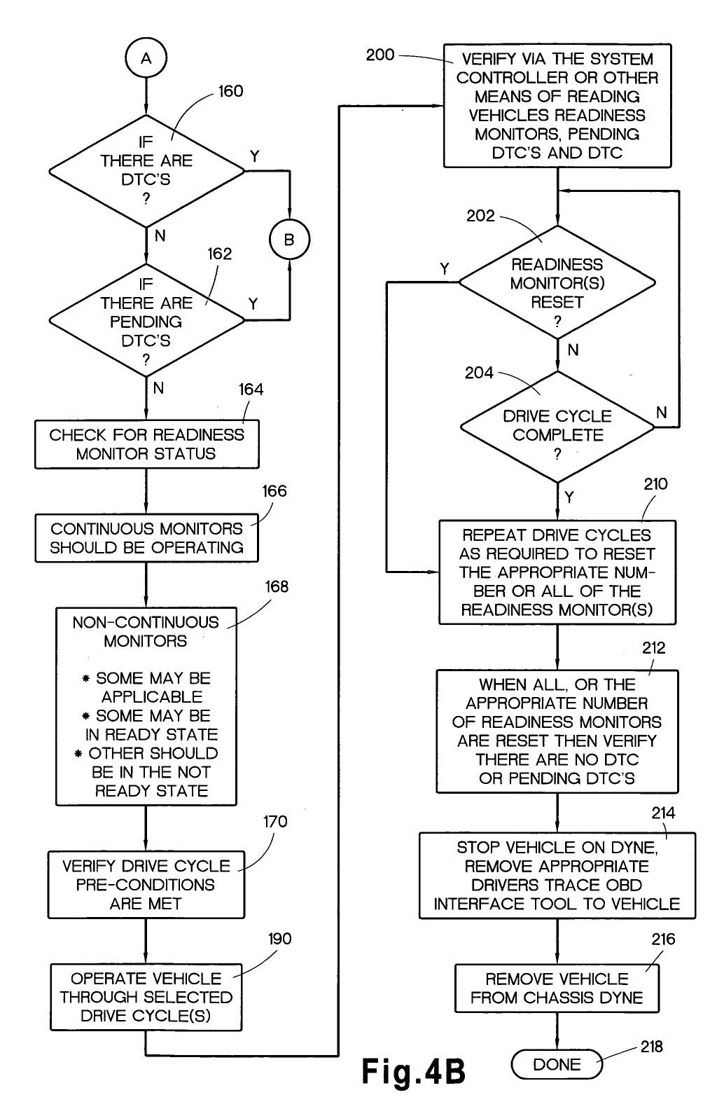

Referring to FIG. 4, a control process 100, in accordance with one example embodiment of the present invention for validating the repair, starts at step 102, where a determination is made as to whether a vehicle's emission system needs repaired. If the determination is negative, the process is terminated at step 104. If the determination is affirmative, as may occur as the result of a failure at an emissions testing station or a vehicle operator noticing that the check engine light (MIL) of the vehicle is ON, the vehicle is repaired in step 106. The vehicle's OBD Diagnostic Trouble Code's (DTC's) are reset in step 108. The vehicle 20 is driven onto the test platform 22 in step 110. In step 112, a determination is made as to whether the scan tool has been attached. If not, the appropriate drivers trace OBD interface tool is attached in step 114. A lift 27 of the dynamometer is lowered which lowers the vehicle's drive wheels 30 into contact with the dynamometer rollers 26, 28. The vehicle is driven for a short period to allow it to stabilize on the dynamometer 24. The wheel chocks 32, 34 are positioned and ratchet binder straps 35 are tighten to restrain the vehicle in step 108 via a prompt from the display 64. The appropriate drivers trace OBD interface tool is attached to vehicle. The cooling fan 50 is then turned ON. A test operator, using either the keyboard 62 or the touch display 64 selects the appropriate vehicle test information from that stored in the OBD validation controller 60 print media or other electron media including other devices or computers in step 120.

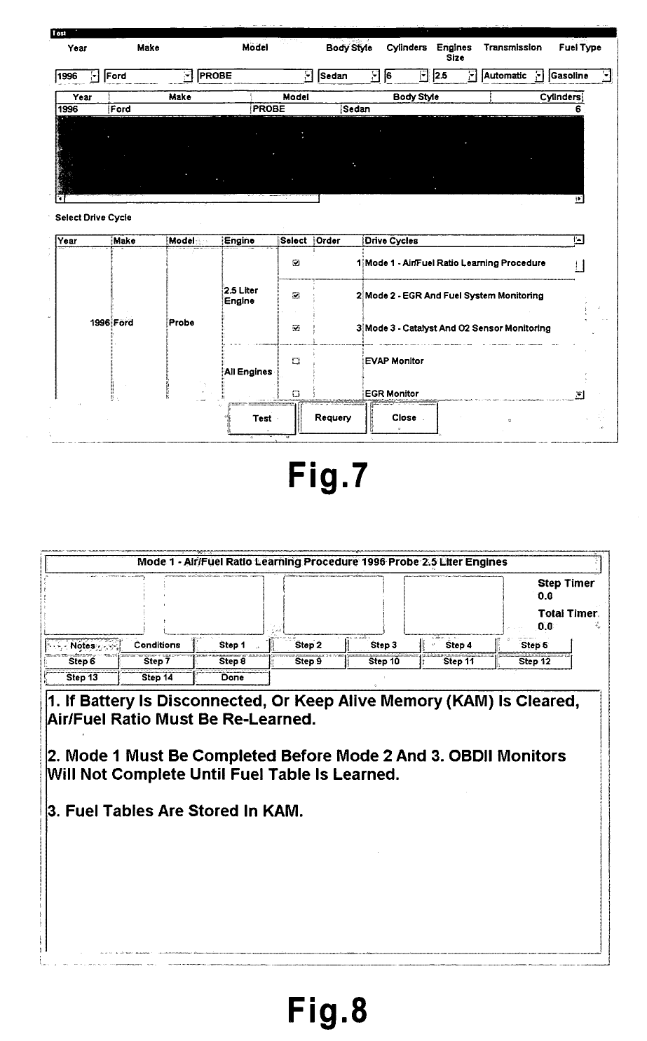

In step 122, the dynamometer loading and/or vehicle drive cycle information is selected or search for in electronic format or in hard copy. In step 124, the appropriate drive cycle for that vehicle is selected so as to reset the readiness monitors. Referring to the graphic user interface screen shot of FIG. 7, since the engine is a 2.5 liter engine, the selected drive cycles are Mode 1—Air/Fuel Ratio Learning Procedure, Mode 2—EGR And Fuel System Monitoring, and Mode 3—Catalyst And O2 Sensor Monitoring. If multiple drive cycles are selected, then the order of the drive cycles to reset the monitors are so ordered in step 126.

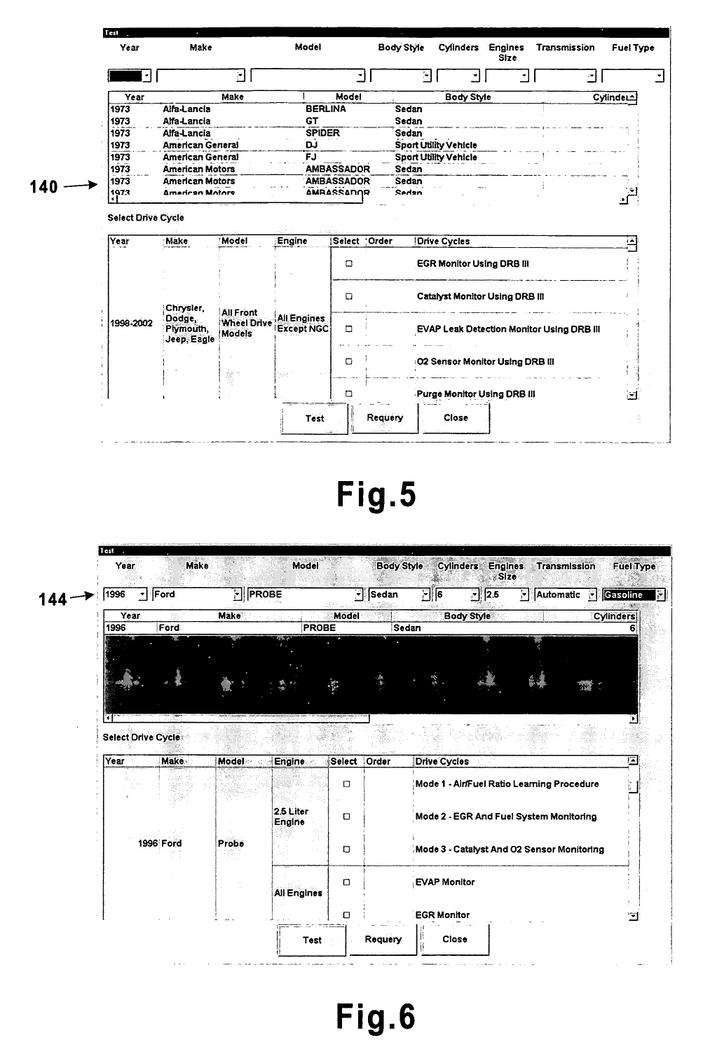

Referring to the graphic user interface screen shots shown in FIGS. 5 and 6, it can be seen that, by way of example, choice of vehicles stored in the OBD controller's memory is displayed in area 140. The operator scrolls down until he finds the vehicle being tested. In this example, a 1996 Ford Probe Sedan, having a 6 cylinder 2.5 liter engine with automatic transmission has been entered in area 144. The vehicle is then put into testing mode if available in step 150. A determination is made in step 152 as to whether the vehicle is running. If negative, the vehicle is started in step 154. From steps 152 or steps 154, the process determines in step 156 as to whether the MIL is ON. If affirmative, the vehicle must be repaired and the process loops back to step 106. If negative, the process goes to step 160 where a determination is made as to whether any DTC's are present. If affirmative, the vehicle needs repaired and the process loops back to step 106. If negative, the process goes to step 162 where a determination is made as to whether any pending DTC's are present. If affirmative, the vehicle needs repaired and the process loops back to step 106. If negative, the process goes to step 164.

In step 164, the readiness of the monitor status is checked. In step 166, continuous monitor operation is checked. Not all of the non-continuous monitors may be applicable for the vehicle under test since not all vehicles are equipped with all possible non-continuous monitors. These non-continuous monitors and their states are noted in step 168.

Referring to FIG. 8, the Mode 1 procedure includes a notes screen, a conditions screen, sixteen step screens, and a done screen. The test operator touches the display screen, first the notes, then the conditions button. He verifies the drive cycle pre-conditions in step 170 are met. The vehicle is operated through selected drive cycles in step 190.

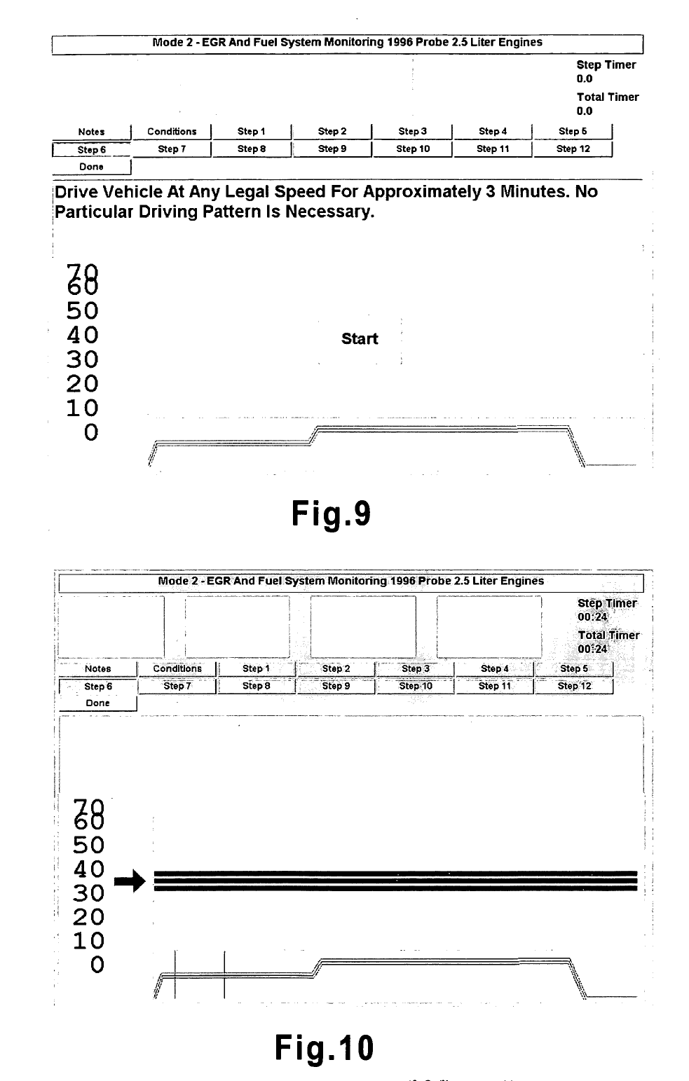

Referring to FIGS. 9 and 10, an actual drive cycle is shown in which the vehicle is “driven” on the dynamometer in step 6 in accordance with the vehicle manufacturers specified drive cycle so as to set the emission vehicle readiness monitors to a Ready or Complete condition. First, the vehicle is driven for 3 minutes at approximately 30 mph. Once the start button on the touch screen of display 64 is pressed, the display of FIG. 10 is shown having three horizontal speed bars. The top and bottom represent upper and low limits, respectively, to aid the test operator in controlling the accelerator pedal 96 to maintain the vehicle speed or throttle position as a function of time according to the graph on the bottom of the screen shot as the two vertical bars move across the screen in time. The arrow on the left shows the vehicle speed as measured back through the dynamometer feedback via the dynamometer internal speed sensors 29 and as monitored by the dynamometer controller 40. In one embodiment, the arrow is maintained green as long as the speed remains within the speed limits and turns red if it goes outside of the limits. The horizontal speed bars move up and down on the speed graph commensurate with the graph on the bottom of the screen shot.

Referring back to FIGS. 4A and 4B, in step 200, the vehicle's readiness monitors, pending DTC's and DTC are verified via the OBD validation controller 60. A determination is made in step 202 as to whether the monitors have been reset. If the determination is negative, the process proceeds to step 204 where an inquiry is made, as to whether the drive cycle is completed. If the determination is negative, the process loops back to step back 202. From positive determinations in either step 202 or 204, the process proceeds to step 210 where the drive cycles are repeated as required to reset the appropriate number or all of the readiness monitors. When all of the readiness or at least the appropriate number of readiness monitors is reset, the fact that there are no DTC and no pending DTC's is verified in step 212. The vehicle is then stopped and removed from the dynamometer and the OBD interface tool disconnected, in steps 214 and 216. The process is finished as indicated in step 218.

One of the screen steps in the graphic user interface displays all relevant vehicle readiness monitors, DTCs, Pending DTCs, freeze frame and data bus information for the vehicle under test. It shows at the conclusion of the drive cycle, step 6 in the example, if the required vehicle readiness monitor conditions have been set to Ready or Complete conditions and there are not DTC set or Pending DTCs thereby validating that the emissions repair was properly done.

From the above description of the invention, those skilled in the art will perceive improvements, changes and modifications. For example, although speed has been used in the described example embodiment as a vehicle control parameter, it should be appreciated that the present invention applied to use of throttle position, acceleration rate, and others that can be used as vehicle control parameters. Also, although a scan tool interface has been described in the example embodiment, a wireless interface can also be used. Such improvements, changes and modifications within the skill of the art are intended to be covered by the appended claims.

1. A method for validating emissions component conditions of a vehicle comprising the steps of:
operatively placing drivable wheel hubs of the vehicle under load so that the vehicle drive wheel hubs may be driven without vehicle movement;
running the vehicle through an associated drive cycle associated with that vehicle;
determining if monitored emission components are in a Ready condition at the end of drive cycle; and
monitoring for diagnostic trouble codes at the end of the drive cycle.

2. The method of claim 1 further comprising the step of:
providing at least one indicia during the running of the vehicle through its associated drive cycle that characterizes a desired operational control parameter of the vehicle.

3. The method of claim 2 wherein the desired operational control parameter of the vehicle is vehicle speed.

4. The method of claim 2 wherein the desired operational control parameter of the vehicle is throttle position.

5. The method of claim 2 wherein the desired operational control parameter of the vehicle is acceleration rate.

6. The method of claim 2 wherein the step of operatively placing the drivable wheel hubs of the vehicle under load includes the step of driving the vehicle onto a dynamometer test stand having a controllable dynamometer.

7. The method of claim 6 wherein the step of operatively placing the drivable wheel hubs of the vehicle under load further includes the step of controlling the dynamometer of the dynamometer test stand according to the associated drive cycle for the vehicle so as to provide desired load conditions.

8. The method of claim 2 wherein the step of monitoring for diagnostic trouble codes includes the step of monitoring for actual diagnostic trouble codes and pending diagnostic trouble codes.

9. The method in claim 2 wherein the step of providing at least one indicia includes the step of providing at least one visual indicia.

10. The method of claim 9 wherein the step of providing said at least one visual indicia includes the step of providing a visual indicia of both a desired control parameter range of the vehicle and a current operating control parameter of the vehicle.

11. The method of claim 10 wherein the desired control parameter range is a speed range and the current operating control parameter of the vehicle is speed.

12. The method of claim 10 wherein the desired control parameter range is a throttle position range and the current operating control parameter of the vehicle is throttle position.

13. The method of claim 10 wherein the desired control parameter range is a acceleration rate range and the current operating control parameter of the vehicle is acceleration rate.

14. The method of claim 10 wherein the step of running the vehicle through the associated drive cycle for that vehicle includes changing the desired operating control parameter of the vehicle at least three times, and wherein the step of providing at least one visual indicia is responsive to the change in the desired operating control parameter of the vehicle.

15. A method for validating emissions component conditions of a vehicle comprising the steps of:
operatively placing drive wheels of the vehicle on a controllable dynamometer;
controlling the dynamometer in accordance with a predetermined control program associated with the vehicle so as to apply appropriate road load forces to the drive wheels of the vehicle during a drive cycle of the vehicle;
operating the vehicle on the dynamometer through an associated drive cycle for that vehicle;
determining if monitored emission components are in a Ready condition at the end of a drive cycle; and
monitoring for diagnostic trouble codes and pending diagnostic trouble codes at the end of the drive cycle.

16. The method of claim 15 further comprising the steps of providing a first indicia that characterizes a desired control parameter range of the vehicle, and providing a second indicia that characterizes a current control parameter of the vehicle.

17. The method of claim 16 wherein the step of providing a first indicia that characterized a desired control parameter range of the vehicle includes providing indicia of a speed range and wherein the step of providing a second indicia that characterizes a current control parameter of the vehicle includes providing indicia of vehicle speed.

18. The method of claim 16 wherein the step of providing a first indicia that characterized a desired control parameter range of the vehicle includes providing indicia of a throttle position range and wherein the step of providing a second indicia that characterizes a current control parameter of the vehicle includes providing indicia of throttle position.

19. The method of claim 16 wherein the step of providing a first indicia that characterized a desired control parameter range of the vehicle includes providing indicia of an acceleration rate range and wherein the step of providing a second indicia that characterizes a current control parameter of the vehicle includes providing indicia of acceleration rate.

20. The method of claim 15 further including the step of using a graphical user interface to select a vehicle platform.

21. The method of claim 15 further comprising the steps of:
determining any repair necessary to correct monitored diagnostic trouble codes and pending diagnostic trouble codes;
repairing the vehicle in accordance with the determined necessary repair; and
repeating all steps of claim 15.

22. An apparatus for validating emissions component conditions of a vehicle comprising:
a simulator for applying appropriate road load forces to the drive hubs of the vehicle during a operation of the vehicle through a drive cycle associated with that vehicle;
a vehicle speed sensor for monitoring speed of vehicle wheels as the vehicle is run on the simulator;
a display for displaying the vehicle drive cycle of the vehicle running on the simulator, said display simultaneously displaying vehicle speed and a desired vehicle speed range during the vehicle drive cycle; and
an interface communication device coupled to the display for communicating the condition of the vehicle's monitored emissions components and diagnostic trouble codes during and at the end of the drive cycle.

23. The apparatus of claim 22 wherein the interface communication device includes a scan tool.

24. The apparatus of claim 22 wherein the interface communication device includes a wireless communication device.

25. The apparatus of claim 22 wherein said scan tool and said display in combination further display diagnostic trouble codes at the end of the drive cycle.

26. The apparatus of claim 22 wherein the simulator is a controllable dynamometer.

27. The apparatus of claim 22 further including a graphical user interface having at least one selector that allows an operator to identify a platform of the vehicle being validated.

28. The apparatus of claim 22 further comprising a database that stores data which characterizes a plurality of drive cycles associated with a plurality of different vehicle platforms and means for selecting the database.

29. A computer readable medium having computer-executable instructions including:
receiving data from that characterizes operating conditions of at least one control module of a vehicle;
controlling a dynamometer to provide appropriate road load forces to drive hubs of the vehicle during a drive cycle of the vehicle;
providing at least one indicia during the running of the vehicle on the dynamometer; and
storing the data received from the scan tool in a database.

30. The computer readable medium of claim 29 wherein the at least one indicia characterizes a current control parameter of the vehicle.

31. The computer readable medium of claim 30 wherein the current control parameter of the vehicle is speed.

32. The computer readable medium of claim 30 wherein the current control parameter of the vehicle is throttle position.

33. The computer readable medium of claim 30 wherein the current control parameter of the vehicle is acceleration rate.

34. The computer readable medium of claim 30 further comprising instructions accessing a directory to retrieve information that characterizes the drive cycle of the vehicle.

35. A method for operating a vehicle on a road simulator to activate and cycle vehicle's on-board-diagnostic readiness monitors comprising the steps of:
identifying the vehicle's platform;
applying a load to drive hubs of the vehicle so as to simulate road load forces;
verifying the vehicle meets pre-conditions for an on-board-diagnostic readiness monitor test;
operating the vehicle through an associated drive cycle for the identified vehicle platform; and
monitoring a state of readiness after the drive cycle.

36. The method of claim 35 further comprising the step of providing at least one indicia that characterizes a desired control parameter the vehicle.

37. The method of claim 36 wherein the step of providing at least one indicia that characterizes a desired control parameter the vehicle includes providing indicia of desired vehicle speed.

38. The method of claim 36 wherein the step of providing at least one indicia that characterizes a desired control parameter the vehicle includes providing indicia of desired vehicle throttle position.

39. The method of claim 36 wherein the step of providing at least one indicia that characterizes a desired control parameter the vehicle includes providing indicia of desired vehicle acceleration rate.

40. The method of claim 36 wherein the step of operating the vehicle through the associated drive cycle includes the steps of applying a plurality of different loads to the vehicle drive hubs wherein each of the plurality of different loads is applied for an associated predetermined duration.

41. The method of claim 40 wherein the at least one indicia is operative to characterize the desired operational speed for the vehicle during the associated drive cycle for each of the plurality of different loads.

42. The method of claim 35 including repeating the steps recited in claim 35 until the monitored state of readiness indicates a predetermined state.

43. A method for operating a vehicle on a road simulator to activate and cycle Readiness Monitors of the vehicle comprising the steps of:
coupling drive wheels of the vehicle to the road simulator so as to apply road load forces to the vehicle;
verifying the vehicle meets predetermined vehicle Readiness Monitor conditions;
operating the vehicle through a predetermined drive cycle to activate vehicle Readiness Monitors through a complete monitor cycle test; and
determine if Readiness Monitors of the vehicle changed Not Ready to Ready state.
